(19) United States
(12) Patent Application Publication
(10) Pub. No.: US 2025/0218060 A1
(43) Pub. Date: Jul. 3, 2025

(54) Work Facility

(71) Applicant: Daifuku Co., Ltd., Osaka-shi (JP)

(72) Inventor: Wataru Kiyokawa, Tokyo (JP)

(21) Appl. No.: 19/002,857

(22) Filed: Dec. 27, 2024

(30) Foreign Application Priority Data
Dec. 28, 2023 (JP) 2023-222606

(51) Int. Cl. G06T 11/00; B65G 1/04; G06Q 10/087; G06V 20/20; H04N 7/18; H04N 23/61

(52) U.S. Cl. CPC G06T 11/00; B65G 1/04; G06V 20/20; H04N 7/183; G06Q 10/087; H04N 23/61

(57) ABSTRACT

A work facility includes a container arrangement section in which a plurality of containers are arrangeable, a work area, and a work assist device to assist the worker in the placement and removal work. The work assist device includes a display device that the worker is capable of wearing in front of the eyes of the worker and that is configured to show the worker an augmented reality image, an article information acquisition system to acquire article information that is information regarding the articles contained in the containers disposed in the container arrangement section, and a control system to control the display device. The control system generates a container transmission image that is the augmented reality image making at least one container out of the containers disposed in the container arrangement section appear transparent and showing the worker an appearance of the articles contained in the at least one container.

### CROSS-REFERENCE TO RELATED APPLICATION

This application claims priority to Japanese Patent Application No. 2023-222606 filed Dec. 28, 2023, the disclosure of which is hereby incorporated by reference in its entirety.

### BACKGROUND OF THE INVENTION

### 1. Field of the Invention

The present invention relates to a work facility.

### 2. Description of Related Art

For example, JP 2014-043353A discloses a technology related to a work facility.

The work facility (picking facility) of JP 2014-043353A includes a storage rack (3) for storing a plurality of containers, a work area for a worker to perform picking work on these containers, and a work assist device (augmented reality device) for assisting in the picking work. The work assist device includes a display device (AR glasses 5) to be worn by the worker. In addition to a view of the physical space, the display device displays a work instruction image overlapping with a portion of the view. The work instruction image includes, for example, information designating a container to be subjected to picking, and information on the number of articles to be removed from the container. The worker performs picking work in accordance with the content of the work instruction image displayed on the display device.

In the work facility of JP 2014-043353A, the worker performs the work of placing and removing articles while ascertaining the state of the inside of the container (e.g., the position and orientation of each article) by looking into the container from an opening part of the container. However, the worker may not be able to easily see the inside of the container. In that case, the worker will feel for articles to perform the work of placing and removing them without ascertaining the state of the inside of the container, and it may take time to pick up the articles in the container, or the worker may mistakenly remove from the container an article of a type different from the content of the work instruction image, which may reduce the work efficiency.

### SUMMARY OF THE INVENTION

A technique is desired that enables the work of placing and removing articles into and out of containers to be easily performed in a work facility equipped with a container arrangement section in which a plurality of containers are arranged.

A work facility according to the present disclosure is a work facility including:
a container arrangement section in which a plurality of containers are arrangeable;
a work area for a worker to perform placement and removal work of placing and removing articles into and out of the containers, the work area being adjacent to the container arrangement section; and
a work assist device configured to assist the worker in the placement and removal work,
wherein the work assist device includes:
   a display device that the worker is capable of wearing in front of the eyes of the worker and that is configured to show the worker an augmented reality image;
   an article information acquisition system configured to acquire article information that is information regarding the articles contained in the containers disposed in the container arrangement section; and
   a control system configured to control the display device, and
the control system generates a container transmission image that is the augmented reality image making at least one container out of the containers disposed in the container arrangement section appear transparent and showing the worker an appearance of the articles contained in the at least one container, based on the article information acquired by the article information acquisition system, and causes the display device to display the container transmission image.

According to this configuration, even if the inside of a container disposed in the container arrangement section cannot be seen as it is by the worker in the work area, such as in a case where the worker performs the work of placing and removing articles into and out of a container disposed at an upper level of the rack, the worker can ascertain the state of the inside of the container by viewing the container transmission image as an augmented reality image displayed on the display device.

Thus, according to this configuration, the work of placing and removing articles into and out of containers can easily be performed in the work facility equipped with a container arrangement section in which a plurality of containers are arranged.

Further features and advantages of the work facility will be apparent from the following description of illustrative and non-limiting embodiments described with reference to the drawings.

### BRIEF DESCRIPTION OF THE DRAWINGS

FIG. 1 is a schematic side view of a work facility.

FIG. 2 is a schematic plan view of the work facility.

FIG. 3 is a control block diagram.

FIG. 4 is an enlarged view of a main part schematically showing an augmented reality image (container transmission image).

FIG. 5 is a control flow diagram.

### DESCRIPTION OF THE INVENTION

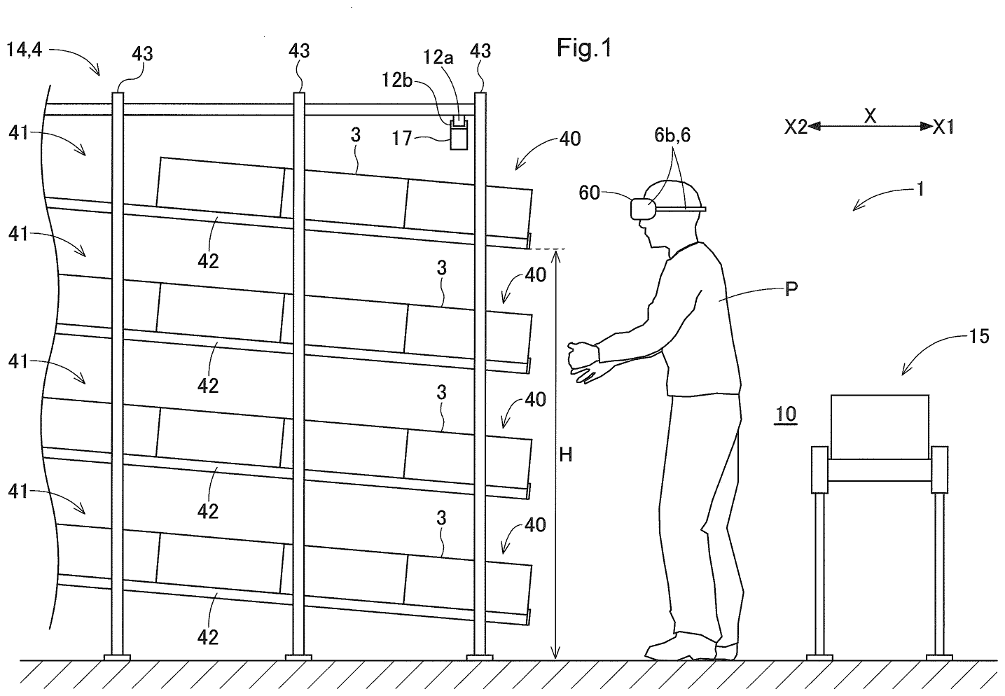

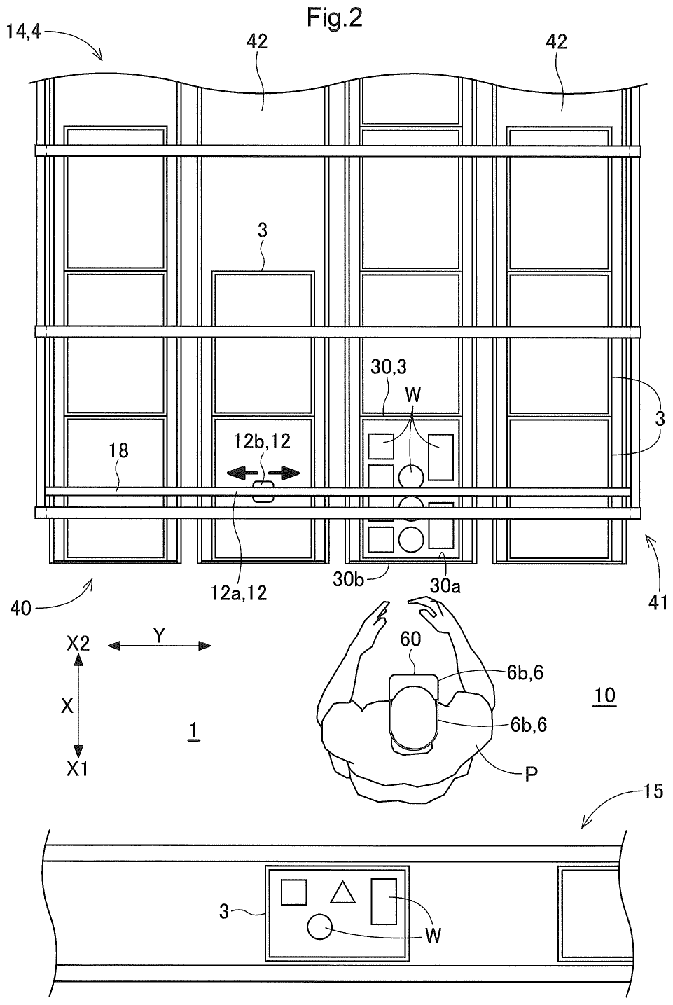

An embodiment of a work facility 1 will be described below with reference to the drawings. The work facility 1 includes a container arrangement section 4 in which a plurality of containers 3 are arranged, a work area 10 that is located adjacent to the container arrangement section 4 and in which a worker P performs work of placing and removing articles W into and out of the containers 3, and a work assist device 5 that assists the worker P in the placement and removal work, as shown in FIGS. 1 and 2. The work facility 1 also includes a transport conveyor 15 located adjacent to the work area 10. Here, the container arrangement section 4 is located adjacent to the work area 10 on the opposite side to the transport conveyor 15. The work area 10 is therefore sandwiched between the container arrangement section 4 and the transport conveyor 15 as viewed in the up-down direction.

In this example, the “work of placing and removing articles W into and out of containers 3” refers to the work of removing articles W from containers 3 disposed in the container arrangement section 4 (picking work). Specifically, the worker P removes articles W from one of the plurality of containers 3 disposed in the container arrangement section 4 and places the removed articles W into another container 3 disposed on the transport conveyor 15. Each container 3 of the present embodiment is open on its upper side, as shown in FIG. 2. Accordingly, the worker P performs the work of placing and removing articles into and out of the inside of the container 3 through the opening part on the upper side thereof. Here, the container 3 is a rectangular parallelepiped carton, but the invention is not limited thereto. The container 3 may alternatively be, for example, a container (including a foldable container). The shape of the container 3 may be a shape other than a rectangular parallelepiped shape (e.g., a cylinder).

As shown in FIGS. 1 and 2, the container arrangement section 4 is a work rack 14 in which a plurality of shelves 41 are arranged in the up-down direction and the containers 3 are disposed on the respective shelves 41. That is, a plurality of containers 3 can be disposed in the up-down direction in the container arrangement section 4. Further, the plurality of containers 3 can be arranged in the horizontal direction on each of the plurality of shelves 41. In this example, the shelf 41 at each level has a placement/removal opening 40 for the worker P to perform the work of placing and removing articles W into and out of the containers 3. A plurality of containers 3 can be disposed side by side in the placement/removal opening 40. Here, the term “arrangement direction Y” refers to the direction in which the plurality of containers 3 are arranged in the placement/removal opening 40. The term “transfer direction X” refers to a direction orthogonal to the arrangement direction Y as viewed in the up-down direction. In this example, the work rack 14, the work area 10, and the transport conveyor 15 are disposed in this order in the transfer direction X. The term “first side X1 in the transfer direction” refers to the side on which the work area 10 is located relative to the work rack 14, and the term “second side X2 in the transfer direction” refers to the opposite side (the side on which the work rack 14 is located relative to the work area 10).

The work rack 14 includes a plurality of columns 43 and a plurality of supports 42 supporting the containers 3 from below, as shown in FIGS. 1 and 2. The supports 42 are plate-shaped members, each of which is elongate in the transfer direction X, and can support the plurality of containers 3 in a state of being arranged in the transfer direction X. The plurality of supports 42 are arranged in the up-down direction and the arrangement direction Y, and are supported by the plurality of columns 43. The spacing between the supports 42 arranged in the up-down direction is larger than the dimension in the up-down direction of each container 3 supported by each support 42, and has a sufficient dimension for the worker P to put their hand through the opening part of the container 3 and remove articles W out of the inside of the container 3. A plurality of supports 42 arranged in the arrangement direction Y at the same level and a space in which the containers 3 are placed on these supports 42 form a shelf 41 corresponding to one level. The placement/removal opening 40 in this example is formed at an end of the shelf 41 at each level, on the first side X1 in the transfer direction (see FIGS. 1 and 2).

In the example shown, each of the supports 42 is inclined downward toward the first side in the transfer direction. A plurality of containers 3 are arranged in the transfer direction X on one support 42, and a container 3 at the rear end (i.e., farthest on the second side X2 in the transfer direction) pushes the other containers 3 located forward of it (i.e., on the first side X1 in the transfer direction) by its own weight. With this, the position of the placement/removal opening 40 in the up-down direction is lowest on the shelf 41 at the same level. Note that, for example, a transport facility or the like for transporting articles W to each support 42 may also be disposed on the second side X2 of the work rack 14 in the transfer direction. Further, the supports 42 need not be inclined as mentioned above. In this case, it is preferable that each support 42 has a conveyor or the like for moving containers 3 in the transfer direction X. The placement/removal opening 40 may alternatively be located at one end of each shelf 41 in the arrangement direction Y. In this case, it is preferable that the work area 10 is adjacent to the work rack 14 on the one side in the arrangement direction Y. The layout in the work facility 1 can thus be changed as appropriate.

As shown in FIGS. 1, 2, and 3, the work facility 1 includes a mover 12 that moves a camera 17 in the arrangement direction Y of the containers 3 in the container arrangement section 4. The mover 12 in this example is provided in correspondence with the placement/removal opening 40 at the uppermost level of the work rack 14 (the container arrangement section 4). Here, the mover 12 includes a rail 12a and a moving unit 12b that supports the camera 17 from above. The moving unit 12b is guided by the rail 12a to move.

As shown in FIGS. 1 and 2, the rail 12a extends along the arrangement direction Y and is located above the containers 3 disposed in the placement/removal opening 40. Further, the rail 12a overlaps with a central region in the transfer direction X of every container 3 disposed in the placement/removal opening 40 as viewed in the up-down direction. The configuration of the camera 17 will be described later.

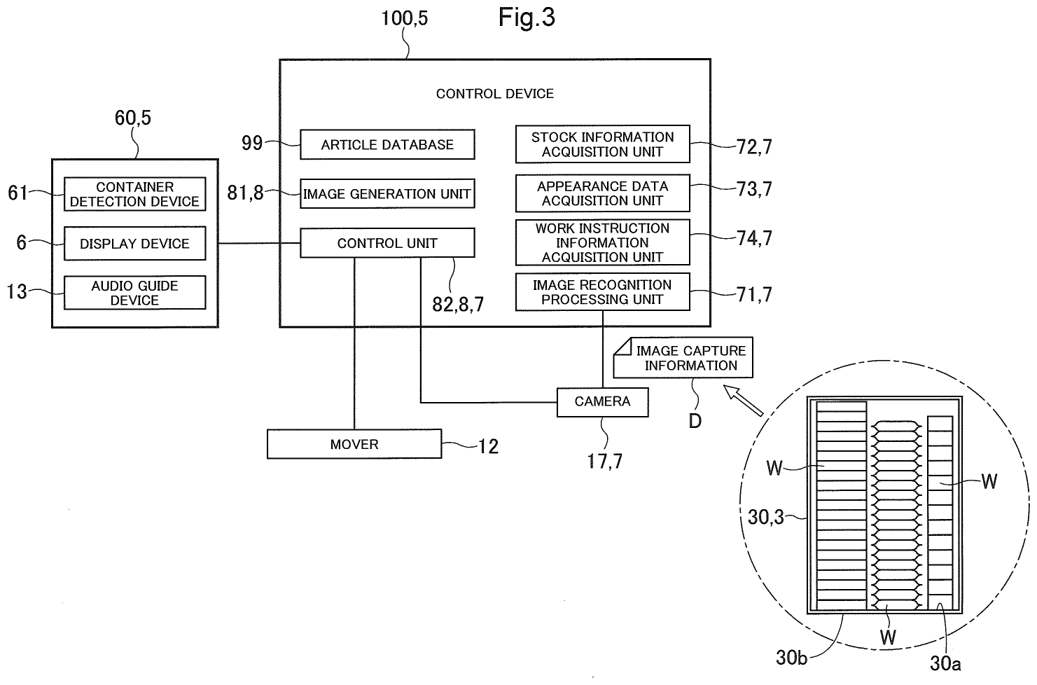

As shown in FIG. 3, the work assist device 5 includes a display device 6 that is worn in front of the eyes of the worker P and shows the worker P an augmented reality image, an article information acquisition system 7 that acquires article information, which is information regarding articles W contained in the containers 3 disposed in the container arrangement section 4, and a control system 8 that controls the display device 6. The work assist device 5 also includes a container detection device 61 that detects the containers 3 disposed in the placement/removal opening 40, and an audio guide device 13.

The display device 6 of the present embodiment includes a display unit 6a in which the augmented reality image is displayed, a communication unit (not shown) that communicates with the control system 8, and a support member 6b that supports the display unit 6a and the communication unit. The communication unit wirelessly communicates with the control system 8. The support member 6b in this example can support the container detection device 61 and the audio guide device 13.

The support member 6b can be attached to the head of the worker P (here, the face of the worker P is also included in the head). The communication unit enables information to be transmitted and received between the control system 8 and the display unit 6a, container detection device 61, and audio guide device 13. At least the display unit 6a, the container detection device 61, the audio guide device 13, and the communication unit are provided in the support member 6b. Here, the display unit 6a, the container detection device 61, the audio guide device 13, the communication unit, and the support member 6b may be collectively referred to as an “external terminal 60”.

The external terminal 60 in the example shown is a pair of goggles, and the display unit 6a (display screen) is provided in a lens section (a section to be placed in front of the eyes of the worker P). The external terminal 60 may alternatively be, for example, a helmet having a lens section. Although the display device 6 in this example has the display unit 6a that is disposed in the lens section of the goggles, the present invention is not limited thereto. For example, the display device 6 may alternatively be a contact lens-type device. In this case, the display device 6 is worn in contact with the cornea of the eye. Accordingly, the phrase “worn in front of the eye” as used herein includes “worn in contact with the eye”.

In this example, the container detection device 61 detects each of the containers 3 arranged in the placement/removal opening 40 at the uppermost level in the container arrangement section 4 (work rack 14). Here, the container detection device 61 is a camera sensor (image capture device). The container detection device 61 detects at least the outer shape of each container 3. The container detection device 61 can also detect as a target container 30 a container 3 to be subjected to the placement and removal work performed by the worker P. The audio guide device 13 is located in the external terminal 60 in correspondence with the position of the ear of the worker P, and guides the worker P wearing the external terminal 60 with a voice by giving a work instruction or the like.

The work facility 1 in this example includes a control device 100 (FIG. 3). The control device 100 performs the functions of the article information acquisition system 7 and the control system 8. The control device 100 includes a processor such as a microcomputer, peripheral circuits such as a memory, and so on. Each function is realized by cooperation of these pieces of hardware and programs executed on the processors such as a computer.

As shown in FIGS. 1 and 3, the article information acquisition system 7 includes a camera 17 that captures an image of the inside of a container 3 from above the container 3, and an image recognition processing unit 71 that performs image recognition processing on the image captured by the camera 17. The camera 17 can capture an image of the inside of each of the containers 3 arranged in the arrangement direction Y in the placement/removal opening 40 from above the container 3. The camera 17 in this example is supported by the moving unit 12b of the mover 12, and is guided by the rail 12a to move in the arrangement direction Y, as mentioned above. The movement path of the camera 17 overlaps with the central region in the transfer direction X of each container 3 disposed in the placement/removal opening 40 as viewed in the up-down direction. The camera 17 can thus capture an image of the entire area of the opening part of each container 3 in the placement/removal opening 40 from above (FIG. 3). The image recognition processing unit 71 is included in the control device 100. The control device 100 can wirelessly communicate with the camera 17, and the image recognition processing unit 71 acquires the image captured by the camera 17 as image capture information D. The image recognition processing unit 71 acquires information (which may be hereinafter referred to simply as “in-container arrangement information”) related to the shapes and the arrangement of a plurality of articles W (more specifically, the shape, orientation, position, and number of articles W) contained in each container 3 in a range that can be checked as viewed in the up-down direction from the image capture information D (image data).

The article information acquisition system 7 also includes a stock information acquisition unit 72 that acquires stock information indicating the types and the number of articles W contained in each of the containers 3 arranged in the container arrangement section 4, and an appearance data acquisition unit 73 that acquires article appearance data, which is data on the appearance of each type of article W. The stock information acquisition unit 72 and the appearance data acquisition unit 73 are included in the control device 100. Here, the stock information and the article appearance data are stored in an article database 99 in the control device 100. The stock information acquisition unit 72 accesses the article database 99 to acquire the stock information (here, the types of articles W and the number of articles W per type) contained in each container 3. The article appearance data is acquired by accessing the article database 99. The article database 99 stores, as article appearance data, images indicating the shape, the size, the design, and the like of the appearance of each article W in association with the type of the article W. Note that the article database 99 may store the shape, the size, the design, and the like of the outer surface of every article W of one type, or may store a selected outer surface having a characteristic shape and/or design. In addition, the article database 99 in this example stores container information indicating the shape, the size, and the like of each container 3. The shape and the size of each container 3 include not only the appearance of the container 3 but also the shape and the size of the inside of the container 3 (i.e., the inner region in which articles W are contained). Note that in this example, the plurality of containers 3 disposed in the placement/removal opening 40 are of the same type (same shape, same size).

The article information acquisition system 7 specifies as a target container 30 a container 3 to be subjected to the placement and removal work performed by the worker P, and causes the mover 12 to move the camera 17 to a position at which the camera 17 can capture an image of the inside of the target container 30. Here, one of the plurality of containers 3 disposed in the placement/removal opening 40 is specified as the target container 30. The control device 100 in this example includes a control unit 82. The control unit 82 controls the mover 12 to move the camera 17 to a position corresponding to the target container 30 (here, directly above the target container 30). Thus, the control unit 82 performs some functions of the article information acquisition system 7.

The control system 8 generates a container transmission image 9, which is an augmented reality image that makes at least some of the containers 3 disposed in the container arrangement section 4 appear transparent and shows the worker P the appearance of articles W contained in the containers 3, based on the article information acquired by the article information acquisition system 7, and causes the display device 6 to display the container transmission image 9. The control unit 82 of the present embodiment controls the display device 6. That is, the control unit 82 causes the display device 6 to display the container transmission image 9. Thus, the control unit 82 performs some functions of the control system 8 in addition to the article information acquisition system 7. The article information includes information indicating the shapes and the arrangement of the articles W, which are the results of image recognition processing. More specifically, the article information includes the shapes and the arrangement of the articles W (the shapes, the orientations, the positions, and the number of articles W), which are the results of image recognition processing. Further, the article information includes the types and the number of articles W indicated by the stock information, and the article appearance data acquired by the appearance data acquisition unit 73. The control system 8 generates the container transmission image 9 based on the shapes and the arrangement of the articles W that are the results of image recognition processing, the types and the number of articles W indicated by the stock information, and the article appearance data acquired by the appearance data acquisition unit 73.

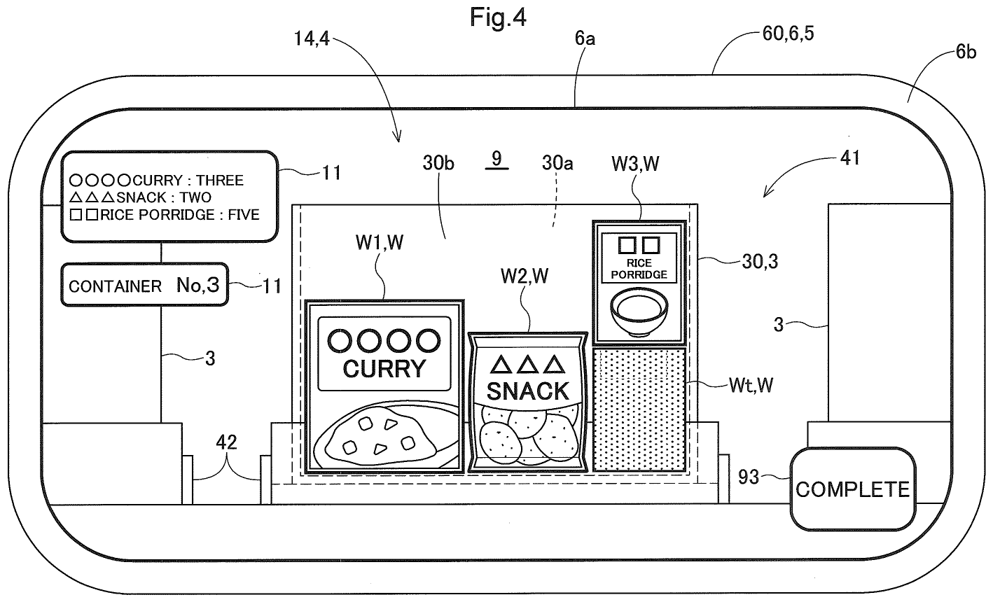

The control system 8 in this example also includes an image generation unit 81. The image generation unit 81 generates the container transmission image 9. Here, the image generation unit 81 is included in the control device 100. Specifically, the image generation unit 81 acquires, from the image recognition processing unit 71, information (hereinafter referred to as “in-container arrangement information”) regarding the shapes and arrangement of the articles W (more specifically, the shapes, the orientations, the positions, and the number of articles W) contained in the target container 30 within a range that can be checked as viewed in the up-down direction. The image generation unit 81 also acquires the stock information regarding the target container 30 (the types of the articles W contained in the target container 30 and the number of articles W per type) from the stock information acquisition unit 72. Further, the image generation unit 81 acquires, from the appearance data acquisition unit 73, article appearance data (image data indicating the shape, the size, the design, and the like of the appearance of each article W) corresponding to each type of article W included in the stock information. Furthermore, the image generation unit 81 acquires the container information from the article database 99. The image generation unit 81 generates the container transmission image 9 by associating the in-container arrangement information, the stock information, the article appearance data, and the container information with each other. Specifically, the image generation unit 81 specifies the type (here, article name) of each of the articles W included in the in-container arrangement information by checking the shape of each article W included in the in-container arrangement information, the article appearance data, and articles W included in the stock information against each other. After specifying the type of each article W in the in-container arrangement information, the image generation unit 81 specifies the appearance of each of the specified types of articles W as image data. The image generation unit 81 creates the container transmission image 9 of an article W facing the surface (inner end surface 30a) of the inside of the target container 30 on the work area 10 side (i.e., the first side X1 in the transfer direction). The image generation unit 81 creates the container transmission image 9 while estimating how the articles W appear for the worker P based on the article appearance data, in-container arrangement information, and detection information from the container detection device 61. Here, the container transmission image 9 is displayed as a virtual appearance image of the articles W facing the inner end surface 30a in correspondence with the positions, orientations, and the sizes of the articles W included in the in-container arrangement information (see FIG. 4). In this example, a peripheral edge portion and a design (including characters) that form an opposing surface of each article W that faces the inner end surface 30a are displayed as the container transmission image 9.

In the example in FIG. 4, a box-shaped article W1, a bag-shaped article W2, a small-sized article W3, and an unknown article Wt are illustrated as the articles W. For the box-shaped article W1, the bag-shaped article W2, and the small-sized article W3, the design on the surface (opposing surface facing the inner end surface 30a) and the peripheral edge portion of the surface of each article W are displayed as the container transmission image 9. The unknown article Wt disposed below the small-sized article W3 is not given a design in the container transmission image 9.

Thus, if the type or the like of the article W is unknown from the image capture information D acquired by the camera 17 capturing an image, no design is displayed as the container transmission image 9. On the other hand, if the outer shape of the article W can be ascertained from the image capture information D, the outer shape (peripheral edge portion) of the unknown article Wt is displayed as the container transmission image 9 as shown in FIG. 4. Further, if the image generation unit 81 cannot estimate the outer shape of the unknown article Wt, the region in which the unknown article Wt is estimated to be disposed can be displayed with a dashed line or filled in gray, for example. A configuration may also be possible in which if the type of an article W cannot be specified based on the image capture information D, the container transmission image 9 of this article W is not displayed regardless of whether the outer shape of the article W can be ascertained. If the presence of an article W can be ascertained based on the image capture information D but the outer shape and the design thereof cannot be ascertained, it is also possible to simply display a mark, a design, color, or the like indicating the presence of the article W as the container transmission image 9. Furthermore, the peripheral edge portion and the design of an article W in the target container 30 may be displayed more densely as the position of this article W is closer to the inner end surface 30a.

In addition to the peripheral edge portion and the design of an article W, the region of the target container 30 containing the article W can also be virtually displayed as the container transmission image 9. It is preferable that the displayed content of the container transmission image 9 can thus be changed as appropriate.

The display unit 6a of the display device 6 in this example has a transmission-type display screen. The container transmission image 9 generated by the image generation unit 81 is laid out on the display unit 6a so as to be superimposed on an actual scene visible to the worker P. Specifically, the container transmission image 9 is projected on the display screen of the display unit 6a as if the container transmission image 9 is superimposed from the second side X2 in the transfer direction on the surface (surface 30b) facing the work area 10 side (i.e., the first side X1 in the transfer direction) of the actual target container 30. The container transmission image 9 is thus projected so as to be superimposed on the actual view of the surface 30b, thereby generating an augmented reality image. Note that the augmented reality image may alternatively be generated by projecting an image captured by the container detection device 61 (camera sensor) on the display screen of the display unit 6a and combining this image with the container transmission image 9 (generation of an image by mixed reality). Thus, the term “augmented reality image” as used herein also includes an image generated by mixed reality.

The control system 8 of the present embodiment causes the display device 6 to display the container transmission image 9 of a container 3 disposed at a height higher than or equal to a preset height H, as shown in FIG. 1. Here, it is preferable that the height H is set in accordance with the position in the up-down direction of a container 3 that corresponds to the height of the eye line of the worker P. The height H in this example is set to the height of the support 42 corresponding to the placement/removal opening 40 at the uppermost level. The control unit 82 controls the display device 6 so as to display the container transmission image 9 of only the target container 30 among the plurality of containers 3 disposed in the placement/removal opening 40 at the uppermost level. Therefore, the container detection device 61 is configured to detect only the container 3 disposed in the placement/removal opening 40 at the uppermost level. This configuration can reduce the computational load on the control device 100 compared with the case where the container transmission image 9 is displayed for all of the containers 3 in the placement/removal opening 40 at the uppermost level regardless of whether they are target containers 30. In addition, the worker P can easily recognize the target container 30, and the efficiency of the placement and removal work can be improved.

Here, with the container detection device 61 having detected the target container 30, the surface 30b of the target container 30 is visible within the range of the display screen of the display unit 6a. Upon the container detection device 61 detecting the target container 30, the container transmission image 9 is displayed in the range of the surface 30b that is visible to the worker P (i.e., a region within the range of the display screen on the surface 30b). The container transmission image 9 is displayed in correspondence with the position, the orientation, and the size of each article W disposed in the target container 30, as mentioned above. Further, it is preferable that the container transmission image 9 is displayed in correspondence with a relative change in the orientation of the surface 30b relative to the display unit 6a. Specifically, if, for example, the worker P visually recognizes the surface 30b from obliquely above while wearing the external terminal 60, it is preferable that the container transmission image 9 is also displayed in a changed orientation corresponding to the orientation of the surface 30b within the range of the display screen. That is, the image generation unit 81 can generate the container transmission image 9 in real time, and the control unit 82 can change the container transmission image 9 displayed on the display unit 6a in real time. This configuration allows the worker P to constantly view the container transmission image 9 in a natural state as an augmented reality image. Note that the control unit 82 can also cause the container transmission image 9 to be displayed for all of the containers 3 in the placement/removal opening 40 at the uppermost level regardless of whether they are the target container 30.

The article information acquisition system 7 of the present embodiment also includes a work instruction information acquisition unit 74 that acquires work instruction information, which is information indicating the content of an instruction for the worker P regarding the placement and removal work.

Here, the work instruction information is set for each of the containers 3 disposed in the placement/removal opening 40. Specifically, the type and the number of articles W to be removed by the worker P from each container 3 are stored as work instruction information in the work instruction information acquisition unit 74. Here, the work instruction information is input in advance by the worker P, and the work instruction information acquisition unit 74 acquires and stores the input work instruction information. Here, the article names (product names) are shown as examples of the types of the articles W (FIG. 4), but the invention is not limited thereto. Further, the control system 8 of the present embodiment generates a work instruction image 11, which is an image indicating the work instruction information, and causes the display device 6 to display the work instruction image 11 in a mode different from the container transmission image 9, as shown in FIG. 4. The image generation unit 81 generates the work instruction image 11 based on the work instruction information regarding the target container 30. Here, the product names of the articles W to be removed by the worker P, the number of articles W per product, and the number of the container designated as the target container 30 are displayed in the work instruction image 11. The work instruction image 11 is generated each time the target container 30 is changed, and is displayed on the display screen of the display unit 6a. Thus, a digital display (an example of a display device) for displaying the work instruction information is not provided at the placement/removal opening 40 at the uppermost level where the container 3 for which the container transmission image 9 is displayed is disposed. Further, the container transmission image 9 is not displayed for the containers 3 disposed in the placement/removal opening 40 at levels other than the uppermost level, as mentioned above. Accordingly, it is preferable that a digital display is provided at the placement/removal opening 40 at the levels other than the uppermost level. Furthermore, in this example, the audio guide device 13 can also provide the worker P with audio guide of the content of the work instruction information. The worker P can also perform the placement and removal work in accordance with the work instruction information regarding which the audio guide device 13 provides the worker P with the audio guide.

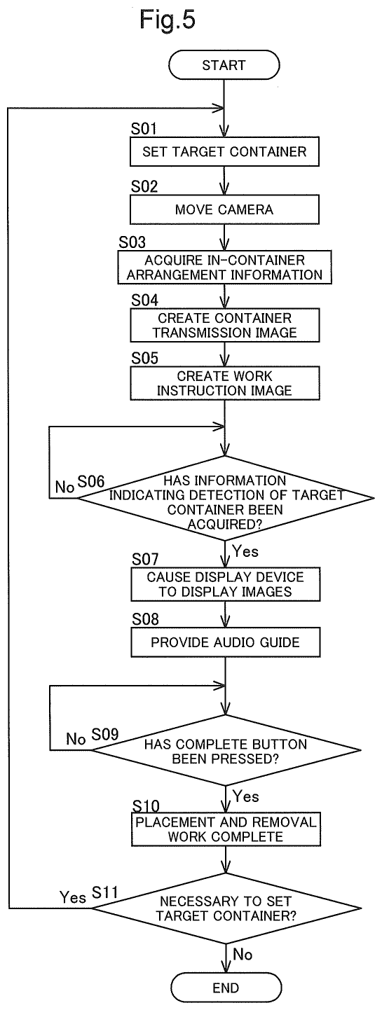

As shown in FIG. 5, the control device 100 sets the target container 30 (S01), and then controls the mover 12 to move the camera 17 to a position corresponding to the target container 30 (S02). Thereafter, the control device 100 acquires the in-container arrangement information based on the image capture information D (S03), then creates the container transmission image 9 based on the article information (in-container arrangement information, stock information, article appearance data) (S04), and creates the work instruction image 11 based on the work instruction information (S05). Thereafter, if the control device 100 acquires information indicating that the container detection device 61 has detected the target container 30 (S06: Yes), then the control device 100 causes the display device 6 to display the container transmission image 9 and the work instruction image 11 (S07). The control device 100 also provides audio guide of the content of the work instruction information (S08). Although not shown in FIG. 5, the control device 100 controls the display device 6 so as not to display the container transmission image 9 and the work instruction image 11 in response to the container detection device 61 no longer detecting the target container 30. Note that the time when the container transmission image 9 and the work instruction image 11 are generated and the time when the container transmission image 9 and the work instruction image 11 are displayed may be the same or may be set in an order different from that shown in FIG. 5.

Here, a complete button 93 indicating completion of the placement and removal work is displayed on the display device 6 (here, the display screen of the display unit 6a), as shown in FIG. 3. In the example shown, the complete button 93 is located at the lower right of the drawing of the display screen. The container detection device 61 (here, the camera sensor) can detect operations of the worker P. The worker P performs an operation of pressing the complete button 93 on the display screen after completing the placement and removal work for the target container 30 in accordance with the content of the work instruction. In response to receiving, from the container detection device 61, information indicating that the operation of pressing the complete button 93 has been detected (S09: Yes), the control device 100 recognizes that the placement and removal work for the target container 30 has been completed (S10). If the next target container 30 needs to be newly set (S11: Yes), the control device 100 sets a target container 30 (S01). Note that the control device 100 may alternatively recognize the completion of the placement and removal work for the target container 30 in response to the voice uttered by the worker P.

### Other Embodiments

(1) In the above embodiment, an example configuration has been described in which the work of removing articles W out of the containers 3 disposed in the container arrangement section 4 has been described as the work of placing and removing articles W into and out of the containers 3. However, the invention is not limited thereto. The work of placing articles W into the containers 3 disposed in the container arrangement section 4 may also be the work of placing and removing articles W into and out of the containers 3.

(2) In the above embodiment, an example configuration has been described in which each container 3 is open on its upper side, and the article information acquisition system 7 includes the camera 17 that captures an image of the inside of the container 3 from above the container 3. However, the invention is not limited thereto. For example, the container 3 may alternatively have a sealed structure that is not open on its upper side, and the article information acquisition system 7 may include a device (e.g., an X-ray inspection device) that detects articles W inside the container 3 by penetrating the container 3, instead of the camera 17.

(3) In the above embodiment, an example configuration has been described in which the article information acquisition system 7 specifies as a target container 30 a container 3 to be subjected to the placement and removal work performed by the worker P, and causes the mover 12 to move the camera 17 to a position at which the camera 17 can capture an image of the inside of the target container 30. However, the invention is not limited thereto. For example, a configuration may alternatively be employed in which the article information acquisition system 7 does not include the mover 12. In this case, a plurality of cameras 17 corresponding to a plurality of containers 3 can be at the placement/removal opening 40 at the uppermost level.

(4) In the above embodiment, an example configuration has been described in which the control system 8 generates the container transmission image 9 based on the shapes and the arrangement of articles W that are the results of image recognition processing, the types and the number of articles W indicated by the stock information, and the article appearance data acquired by the appearance data acquisition unit 73. However, the invention is not limited thereto. For example, the control system 8 may generate the container transmission image 9 without using the article appearance data. In this case, for example, the container transmission image 9 can be generated such that a product name or a mark indicating a product is displayed at a location where each article W is estimated to be disposed in the container transmission image 9.

(5) In the above embodiment, an example configuration has been described in which the control system 8 causes the display device 6 to display the container transmission image 9 of a container 3 disposed at a height higher than or equal to the preset height H. However, the invention is not limited thereto. For example, the control system 8 may alternatively cause the display device 6 to display the container transmission image 9 of containers 3 disposed in all of the placement/removal openings 40 in the container arrangement section 4 (work rack 14).

(6) In the above embodiment, an example configuration has been described in which the control system 8 generates the work instruction image 11, which is an image indicating work instruction information, and causes the display device 6 to display the work instruction image 11 in a mode different from the container transmission image 9. However, the invention is not limited thereto. For example, the control system 8 can also cause an output device different from the display device 6 to output the work instruction image 11. For example, the control system 8 can also cause the work instruction screen to be displayed directly on the surface 30b of the target container 30 without using the display device 6. Alternatively, a screen can be installed in the work area 10, and the work instruction screen can be displayed on this screen.

(7) Note that the configuration disclosed in the above embodiment can also be applied in combination with configurations disclosed in other embodiments as long as no contradiction arises. Regarding other configurations as well, the embodiment disclosed herein is merely an example in all respects. Accordingly, various modifications can be made, as appropriate, without departing from the gist of the present disclosure.

### Summary of the Above Embodiment

The summary of the above-described work facility is described below.

A work facility according to the present disclosure is a work facility including:
a container arrangement section in which a plurality of containers are arrangeable;
a work area for a worker to perform placement and removal work of placing and removing articles into and out of the containers, the work area being adjacent to the container arrangement section; and
a work assist device configured to assist the worker in the placement and removal work,
wherein the work assist device includes:
   a display device that the worker is capable of wearing in front of the eyes of the worker and that is configured to show the worker an augmented reality image;
   an article information acquisition system configured to acquire article information that is information regarding the articles contained in the containers disposed in the container arrangement section; and
   a control system configured to control the display device, and
the control system generates a container transmission image that is the augmented reality image making at least one container out of the containers disposed in the container arrangement section appear transparent and showing the worker an appearance of the articles contained in the at least one container, based on the article information acquired by the article information acquisition system, and causes the display device to display the container transmission image.

According to this configuration, even if the inside of a container disposed in the container arrangement section cannot be seen as it is by the worker in the work area, such as in a case where the worker performs the work of placing and removing articles into and out of a container disposed at an upper level of the rack, the worker can ascertain the state of the inside of the container by viewing the container transmission image as an augmented reality image displayed on the display device.

Thus, according to this configuration, the work of placing and removing articles into and out of containers can easily be performed in a work facility equipped with a container arrangement section in which a plurality of containers are arranged.

Here, it is preferable that each of the containers is open on an upper side thereof,
the article information acquisition system includes:
   a camera configured to capture an image of inside of the containers from above the containers; and
   an image recognition processing unit configured to perform image recognition processing on the image captured by the camera, and
the article information includes information indicating a shape and an arrangement of the articles, the shape and the arrangement being results of the image recognition processing.

According to this configuration, it is possible to acquire, as the article information, information indicating the shapes and the arrangement of articles based on the actual state of the inside of the container whose image has been captured by the camera. Accordingly, an appropriate container transmission image can be generated.

It is preferable that the work facility further includes a mover configured to move the camera along an arrangement direction of the containers in the container arrangement section,
wherein the article information acquisition system specifies as a target container a container to be subjected to the placement and removal work performed by the worker, and causes the mover to move the camera to a position at which the camera is capable of capturing an image of inside of the target container.

According to this configuration, the number of cameras can be kept small with respect to the number of containers for which the container transmission image may be displayed. Therefore, the cost of the work facility can be easily reduced.

It is preferable that the article information acquisition system further includes:
a stock information acquisition unit configured to acquire stock information indicating a type and the number of articles contained in each of the plurality of containers arranged in the container arrangement section, and
an appearance data acquisition unit configured to acquire article appearance data that is data on an appearance of each type of article, and
the control system generates the container transmission image based on the shape and the arrangement of the articles, the shape and the arrangement being the results of image recognition processing, the type and the number of articles indicated by the stock information, and the article appearance data acquired by the appearance data acquisition unit.

According to this configuration, the container transmission image is based on the shapes and the arrangement of articles that are the results of image recognition processing, the types and the number of articles indicated by the stock information, and the article appearance data acquired by the appearance data acquisition unit. Thus, it is possible to generate a container transmission image that accurately reproduces the inside of a container. Accordingly, the worker can ascertain the state of the inside of the container in more detail by viewing such a container transmission image.

It is preferable that the container arrangement section is a work rack in which a plurality of shelves are arranged in an up-down direction and the containers are disposed on the shelves, and
the control system causes the display device to display the container transmission image of the containers disposed at a height higher than or equal to a preset height.

According to this configuration, the display device can display the container transmission image of a container whose inside is difficult for the worker to see because the container is disposed at a relatively upper level in the work rack. Therefore, it is possible to facilitate the work of placing and removing articles into and out of the plurality of containers disposed in the work rack.

It is preferable that the article information acquisition system further includes a work instruction information acquisition unit configured to acquire work instruction information that is information indicating content of an instruction for the worker regarding the placement and removal work, and
the control system generates a work instruction image that is an image indicating the work instruction information, and causes the display device to display the work instruction image in a mode different from the container transmission image.

According to this configuration, since the work instruction image is separately displayed on the display device in addition to the container transmission image, the worker can perform the work of placing and removing articles into and out of the containers only by viewing the images displayed on the display device. This makes it easy to improve the efficiency of the work of placing and removing articles into and out of the containers.

The work facility according to the present disclosure need only exhibit at least one of the above-described effects.

What is claimed is:

1. A work facility comprising:
a container arrangement section in which a plurality of containers are arrangeable;
a work area for a worker to perform placement and removal work of placing and removing articles into and out of the containers, the work area located adjacent to the container arrangement section; and
a work assist device configured to assist the worker in the placement and removal work,
wherein the work assist device comprises:
a display device that the worker is capable of wearing in front of the eyes of the worker and that is configured to show the worker an augmented reality image;
an article information acquisition system configured to acquire article information that is information regarding the articles contained in the containers disposed in the container arrangement section; and
a control system configured to control the display device, and
wherein the control system generates a container transmission image that is the augmented reality image making at least one container out of the containers disposed in the container arrangement section appear transparent and showing the worker an appearance of the articles contained in the at least one container, based on the article information acquired by the article information acquisition system, and causes the display device to display the container transmission image.

2. The work facility according to claim 1, wherein:
each of the containers is open on an upper side thereof,
the article information acquisition system comprises:
a camera configured to capture an image of inside of the containers from above the containers; and
an image recognition processing unit configured to perform image recognition processing on the image captured by the camera, and
the article information comprises information indicating a shape and an arrangement of the articles, the shape and the arrangement being results of the image recognition processing.

3. The work facility according to claim 2, further comprising:
a mover configured to move the camera along an arrangement direction of the containers in the container arrangement section, and
wherein the article information acquisition system specifies as a target container a container to be subjected to the placement and removal work performed by the worker, and causes the mover to move the camera to a position at which the camera is capable of capturing an image of inside of the target container.

4. The work facility according to claim 2,
wherein the article information acquisition system further comprises:
a stock information acquisition unit configured to acquire stock information indicating a type and the number of articles contained in each of the plurality of containers arranged in the container arrangement section, and
an appearance data acquisition unit configured to acquire article appearance data that is data on an appearance of each type of article, and
wherein the control system generates the container transmission image based on the shape and the arrangement of the articles, the shape and the arrangement being the results of image recognition processing, the type and the number of articles indicated by the stock information, and the article appearance data acquired by the appearance data acquisition unit.

5. The work facility according to claim 1,
wherein the container arrangement section is a work rack wherein a plurality of shelves are arranged in an up-down direction and the containers are disposed on the shelves, and
wherein the control system causes the display device to display the container transmission image of the containers disposed at a height higher than or equal to a preset height.

6. The work facility according to claim 1,
wherein the article information acquisition system further comprises a work instruction information acquisition unit configured to acquire work instruction information that is information indicating content of an instruction for the worker regarding the placement and removal work, and
wherein the control system generates a work instruction image that is an image indicating the work instruction information, and causes the display device to display the work instruction image in a mode different from the container transmission image.
